(19) United States
(12) Patent Application Publication
(10) Pub. No.: US 2003/0075902 A1
(43) Pub. Date: Apr. 24, 2003

(54) 0ne-hand operational control device of foldable stroller

(76) Inventor: Ben M. Hsia, Northridge, CA (US)

Correspondence Address: Raymond Y. Chan, 1050 Oakdale Lane, Arcadia, CA, 91006, US

(21) Appl. No.: 10/035,703

(22) Filed: Oct. 18, 2001

(51) Int. Cl. B62B 1/00

(52) U.S. Cl. 280/647; 280/655.1

(57) ABSTRACT

A foldable stroller incorporates with a one-hand operational control device which includes a turn switch rotatably mounted on the stroller. A locking unit includes a locking latch slidably disposed a pusher cavity of the turn switch and a finger trigger arranged to move the locking latch inwardly into the pusher cavity. A resilient unit is provided between the locking latch and a bottom surface of the pusher cavity for urging and retaining the locking latch in an outward position that an outer end of the locking latch is extended to block the turn switch from being rotate so as to lock up the stroller from being folded. In order to fold up the stroller, a user's fingers must grip on the finger trigger inwardly to push the locking latch inward. Then, rotate the turn switch to disengage the first engaging members with the second engaging members respectively.

### BACKGROUND OF THE PRESENT INVENTION

1. Field of Invention

The present invention relates to strollers, and more particularly to a one-hand operational control device incorporated with the stroller, wherein the stroller is improved in both safety and operability. The folding process of the stroller requires a simple single-action operation by an adult's hand, which is advantageous in practical use.

2. Description of Related Arts

Stroller becomes a necessity to every family having a young child or baby because it is considered as a conveniences tool to carry the baby or young child during outdoor activities such as foot traveling and shopping. For convenience, the stroller can be quickly and easily unfolded for use and folded into a compact unit for carriage so that a user can carry the stroller everywhere.

Referring to FIG. 1, a conventional foldable stroller comprises a supporting frame, a seat frame pivotally supported by the supporting frame, and a U-shaped handle frame pivotally extended from the supporting frame. The foldable stroller further comprises a locking control device for selectively locking and unlocking the stroller in its unfolded position.

As shown in FIG. 2, the locking control device comprises a pair of first locking members provided at two end portions of the handle frame, a pair of second locking members provided on the supporting frame, and an operation unit comprising a turn switch rotatably mounted on the handle frame and a thumb pusher movable mounted on the turn switch in a vertical movable manner. FIG. 2 illustrates different kinds of the first and second locking members of the locking control device for the conventional foldable stroller.

In order to unlock the foldable stroller, the user must intentionally press the thumb pusher downwardly by his or her thumb and rotate the turn switch backwardly simultaneously so as to drive the first locking members disengaged with the second locking members respectively. Therefore, the user can push the handle frame forwardly to fold up the foldable stroller.

However, such locking control device has a major drawback that the user must use his or her thumb to depress the thumb pusher and turn the turn switch by his or her hand at the same time. Due to the muscular mechanism of the human body, when the user's thumb is pressed on the thumb pusher, the wrist of the user is locked and becomes too tense to turn downwards to rotate the turn switch, especially for women. Similar operation problem occurs when the user must rotate the turn switch backward and, at the same time, push the handle frame forward to fold up the stroller. Therefore, the user may have difficulty to control the two opposite directional operations. In other words, the operation of the locking control device is considered disadvantageous in practical use. When the user operates the locking control device improperly, the user may cause an unwanted injury such as twist his or her wrist.

### SUMMARY OF THE PRESENT INVENTION

A main object of the present invention is to provide a one-hand operational control device of foldable stroller wherein the stroller is improved in both safety and operability. The operation of the device is smooth and easy since it is designed to fit for the muscular mechanism of the human body.

Another object of the present invention is to provide a one-hand operational control device of foldable stroller wherein the foldable stroller requires a simple single-action operation by an adult's hand, wherein the user's thumb push-down operation is eliminated and substituted simply by a gripping action with the user's hand that will not block and lock up the user's wrist for smoothly rotating the user's hand frontwards in order to unlock the stroller. That is much advantageous in practical use.

Another object of the present invention is to provide a one-hand operational control device of foldable stroller which can be quickly and easily folded into a compact unit for carriage and storage and unfolded for use.

Another object of the present invention is to provide a one-hand operational control device of stroller, which does not require to alter the original structural design of the stroller, so as to minimize the manufacturing cost for incorporating the one-hand operational control device with the every conventional stroller having a handle frame.

Accordingly, in order to accomplish the above objects, the present invention provides a foldable stroller, comprising:

a foldable supporting frame;

a handle frame comprising two tubular pivot arms extending downwardly;

a pair of folding joints for pivotally connecting two lower ends of the pivot arms to two sides of the supporting frame respectively;

an engagement unit comprising a pair of first engaging members provided at two lower ends of the pivot arms of the handle frame respectively and a pair of second engaging members provided at the two folding joints and securely engaged with the two first engaging members respectively, so as to lock up the handle frame with respect to the supporting frame; and

an one-hand operational control device, comprising:

a turn switch comprising a central shaft, having a pusher cavity, firmly and coaxially mounted between two upper ends of the two pivot arms and a turning handle, having a guiding slot, rotatably mounted on the central shaft and arranged to drive the first engaging members disengaged with the second engaging members respectively when the turn switch is rotated with respect to the pivot arms;

a locking unit comprising a locking latch disposed in the pusher cavity of the turn switch in a slidably movable manner and a finger trigger extended from the locking latch to outside through the guiding slot, wherein the locking latch is arranged to be driven by the finger trigger to move from a normally locking position to an unlocked position; and

a resilient unit which is disposed in the pusher cavity for applying an urging pressure against the locking latch so as to normally retain the locking latch at the locking position, wherein at the locking position, a locking portion of the locking latch is extended outwardly for blocking up the turn switch from being rotated with respect to the pivot arms so as to lock up the foldable stroller from being folded up, and that at the unlocked position, the locking portion of the locking latch is moved away from the turn switch so as to release the blocking up of the turn switch with respect to the pivot arms, so that the turn switch is capable of being rotated to disengage the first engaging members with the second engaging members for folding the stroller.

### BRIEF DESCRIPTION OF THE DRAWINGS

FIG. 1 is a perspective view of a convention foldable stroller.

FIG. 2 is a perspective view of a locking control device for the conventional stroller.

FIG. 3 is a perspective view of a foldable stroller incorporated with a one-hand operational control device according to a preferred embodiment of the present invention.

FIG. 4 is a sectional perspective view of the foldable stroller incorporated with the one-hand operational control device according to the above preferred embodiment of the present invention, illustrating the folding operation of the foldable stroller.

FIG. 5 is an exploded perspective view of the one-hand operational control device of the foldable stroller according to the above preferred embodiment of the present invention.

FIG. 6 is a sectional view of the one-hand operational control device of the foldable stroller in a normally locking position according to the above preferred embodiment of the present invention.

FIG. 7 is a sectional view of the one-hand operational control device of the foldable stroller in an unlocked position according to the above preferred embodiment of the present invention.

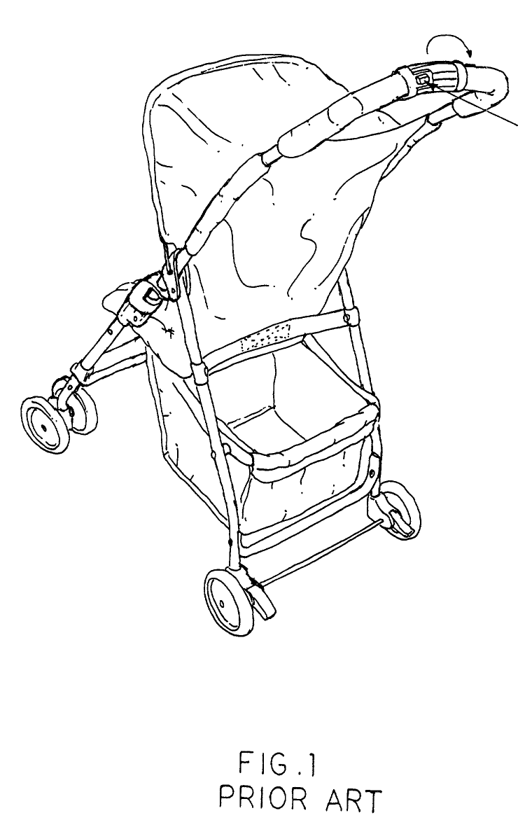

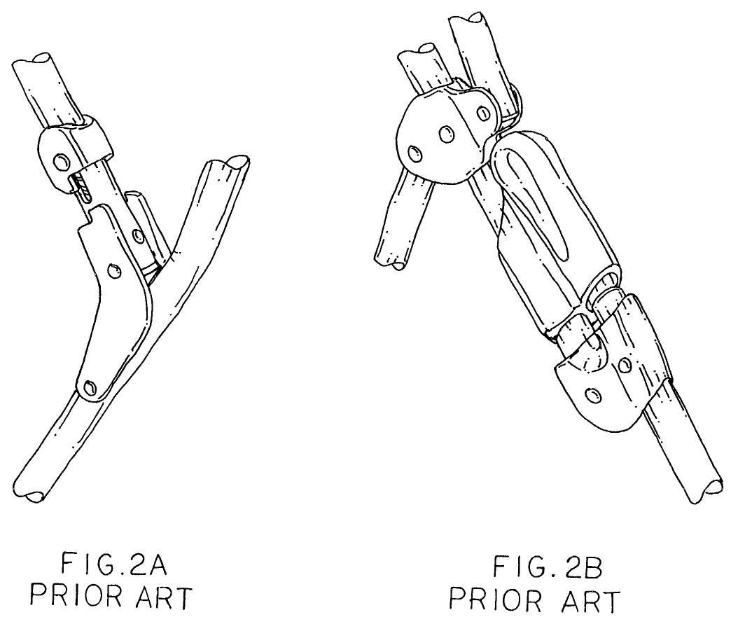

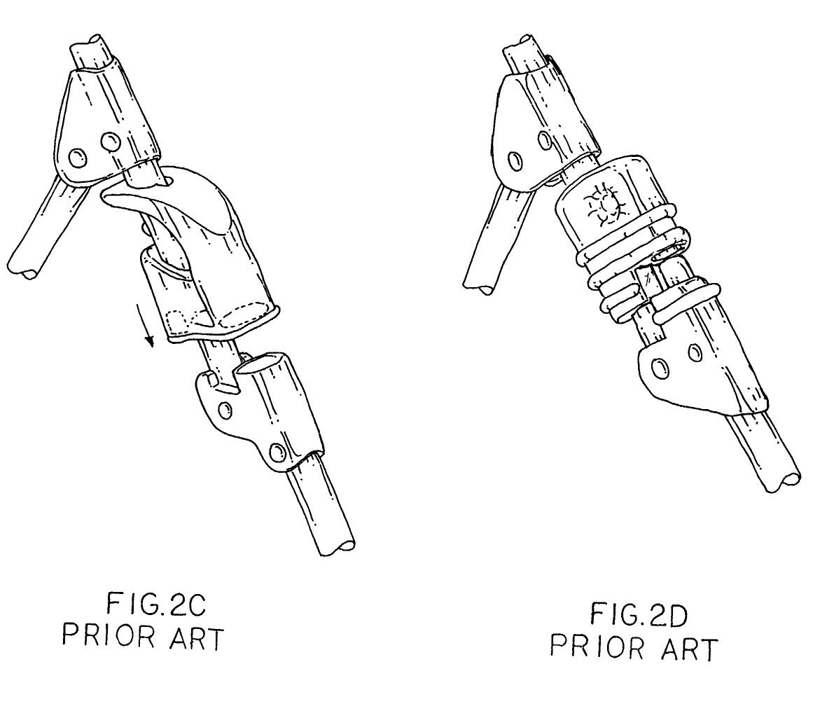

### DETAILED DESCRIPTION OF THE PREFERRED EMBODIMENT

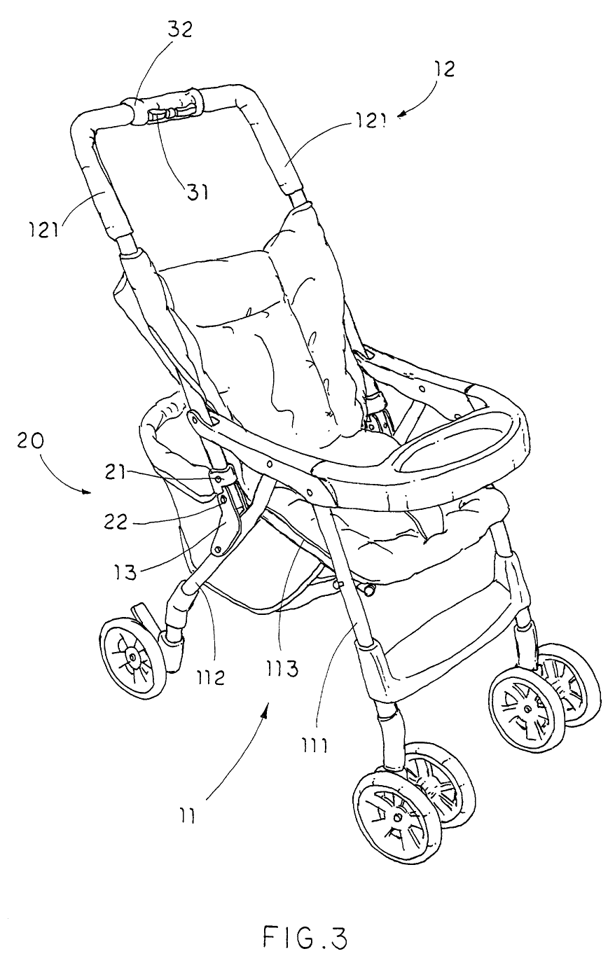

Referring to FIG. 3 of the drawings, a foldable stroller equipped with a one-hand operational control device 2 according to a preferred embodiment of the present invention is illustrated. The foldable stroller 1, such as a standard foldable stroller, comprises a foldable supporting frame 11, a handle frame 12 comprising two tubular pivot arms 121 extending downwardly, and a pair of folding joints 13 is arranged for pivotally connecting two lower ends of the pivot arms 121 to two sides of the back frame 112 of the supporting frame 11 respectively. The foldable stroller 1 further comprises an engaging unit 20 for securely locking up the handle frame 12 with the supporting frame 11.

The supporting frame 11 comprises a front frame 111, a back frame 112 pivotally connected to the front frame 111, and a seat frame 113 pivotally supported by the front and back frames 111, 112. In order to fold up the foldable stroller 1, the handle frame 12 must be pivotally moved forward to the supporting frame 11, so as to fold up the back frame 112 towards to the front frame 111.

The engagement unit 20 comprises a pair of first engaging members 21 provided at two lower ends of the pivot arms 121 of the handle frame 12 respectively and a pair of second engaging members 22 provided at the two folding joints 13 and securely engaged with the two engaging members 21 respectively, so as to lock up the handle frame 12 with respect to the supporting frame 11.

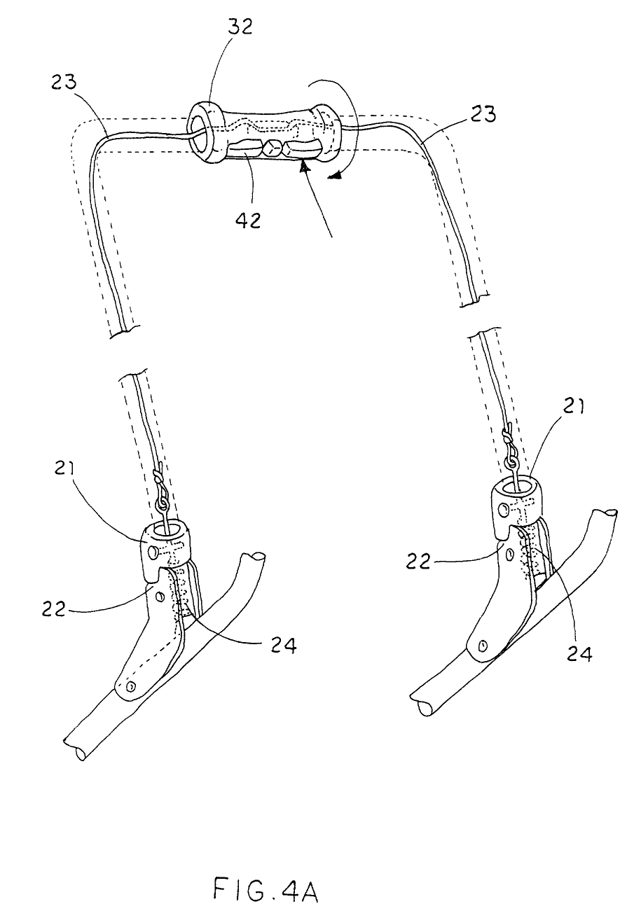

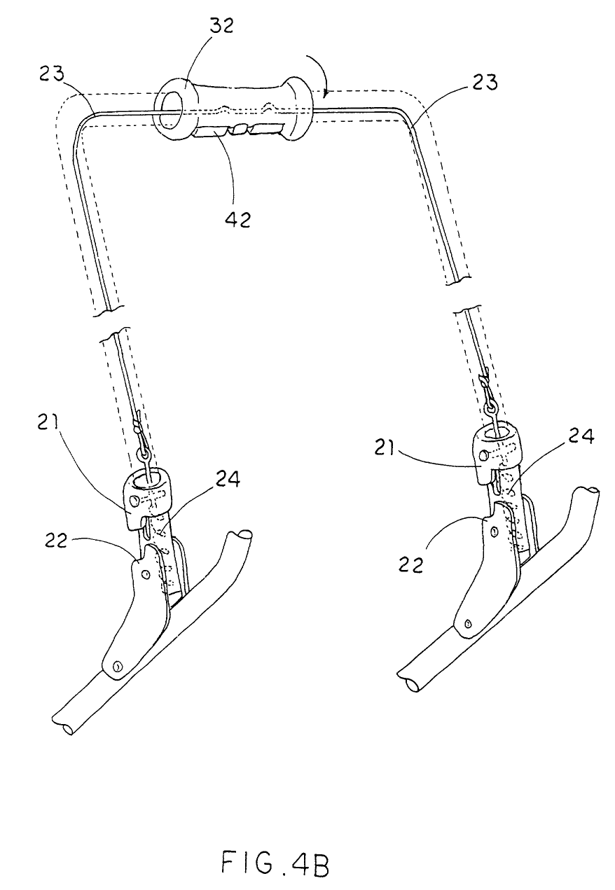

As shown in FIGS. 4 and 5, the one-hand operational control device 2 comprises a turn switch 30, a locking unit 40, and a resilient unit 50.

The turn switch 30 comprises a central shaft 31, having a pusher cavity 311, coaxially mounted between two upper ends of the two pivot arms 121 and a turning handle 32, having a guiding slot 321, coaxially and rotatably mounted on the central shaft 31 wherein the turn switch 30 is arranged to drive the first engaging members 21 disengaged with the second engaging members 22 respectively when the turn switch 30 is rotated with respect to the pivot arms 121, as shown in FIGS. 4A and B.

The locking unit 40 comprises a locking latch 41 perpendicularly disposed in the pusher cavity 311 of the turn switch 30 in a slidably movable manner and a finger trigger 42 extended from the locking latch 41 to outside through the guiding slot 321, wherein the locking latch 41 is arranged to be driven by the finger trigger 42 to move from a normally locking position to an unlocked position.

The resilient unit 50 is disposed in the pusher cavity 311 for applying an urging pressure against the locking latch 41 so as to normally retain the locking latch 41 at the locking position. In which, at the locking position, a locking portion of the locking latch 41 is extended outwardly for blocking up the turn switch 30 from being rotated with respect to the pivot arms 121 so as to lock up the stroller 1 from being folded up, and that at the unlocked position, the locking portion of the locking latch 41 is moved away from the turn switch 30 so as to release the blocking up of the turn switch 30 with respect to the pivot arms 121, so that the turn switch 30 is capable of being rotated to disengage the first engaging members 21 with the second engaging member 22 for folding up the stroller 1.

According to the preferred embodiment, the engagement unit 20 further comprises a pair of elongated elements 23 and a pair of auto-returning elements 24 for applying an urging pressure against the first engaging members 21 to normally engage with the second engaging members 22 respectively.

Each of the elongated elements 23 has an affixing end firmly connected to the central shaft 31 of the turn switch 30 and a control end firmly connected to the respective first engaging member 21 in such a manner that when the turning handle 32 is rotated with respect to the central shaft 31, the first engaging members 21 are disengage with second engaging members 22 via the elongated elements 23 respectively, as shown in FIG. 4. Accordingly, the elongated elements 23, which are two durable wires, extended from the central shaft 31 to the first engaging members 21 through an interior of the pivot arms 121 respectively.

Each of the auto-returning elements 24, which is a resilient element such as compression spring, mounted between the first engaging member 21 and the pivot arm 121. The auto-returning element has two ends biasing against the first engaging member 21 and the pivot arm 121 so as to pushes the first engaging member 21 to a position that the first engaging member 21 is engaged with the second engaging member 22.

The turning handle 32 is coaxially mounted on the central shaft 31 and has a size and shape adapted for fittedly being gripped by a hand of a user to rotate the turning handle 33 with respect to the pivot arms 121. The turning handle 32 further has a blocking wall 322 inwardly extended from an inner surface of the turning handle 32 towards to the pusher cavity 311.

The turn switch 30 further comprises a driving member 34 rotatably connected to the central shaft 31 wherein the driving member 34 has at least a protrusion 341 extended outwardly and engaged with the turning handle 32 so as to ensure the turning handle 32 to be rotated with respect to the central shaft 31. It is worth to mention that the central shaft 31 can be integrally extended between two ends of the pivot arms 121 of the handle frame 12 to form a one-piece member, so as to rigidly support the turning handle 32 in a rotatably movable manner.

As shown in FIG. 4, the turning handle 32 must be rotated forward in order to drive the first engaging members 21 to disengage with the second engaging members 22 via the elongated elements 23 respectively, so as to fold up the foldable stroller 1. In other words, the forward rotational operation of the turn switch 30 has the same direction of the forward folding operation of the handle frame 12 so as to enhance the folding operation of the foldable stroller 1, which is advantage in practical use.

According to the preferred embodiment, the locking latch 41 is slidably fitted in the pusher cavity 311 in a perpendicularly movable manner with respect to the central shaft 31 and an outer end of the locking latch 41 functions as the locking portion. At the normal locking position, the outer end (locking portion) of the locking latch 41 is normally extended towards to the blocking wall 322 of the turning handle 32 in order to block the turning handle 32 from being rotated with respect to the pivot arms 121.

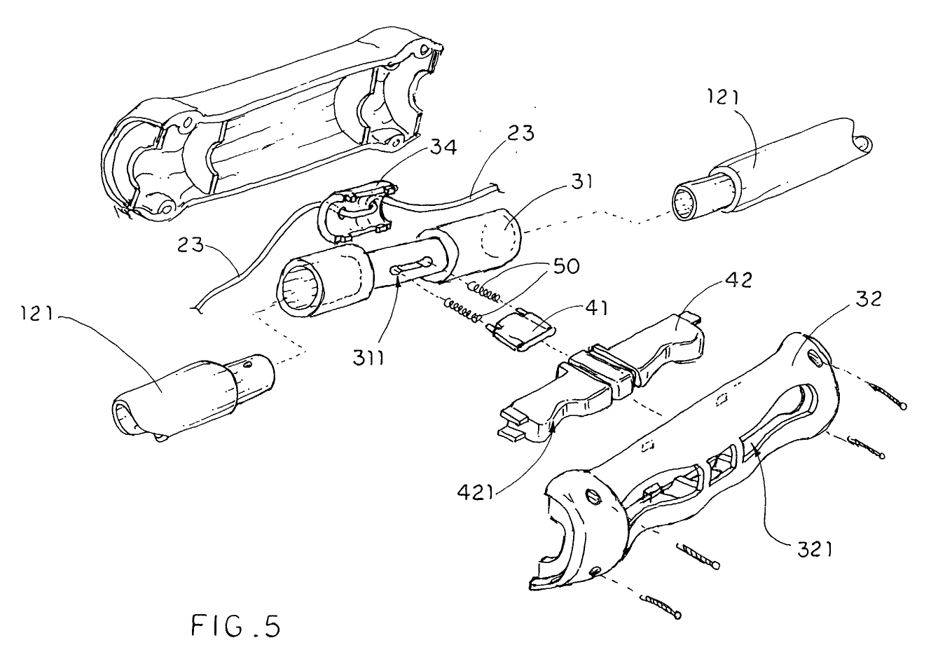

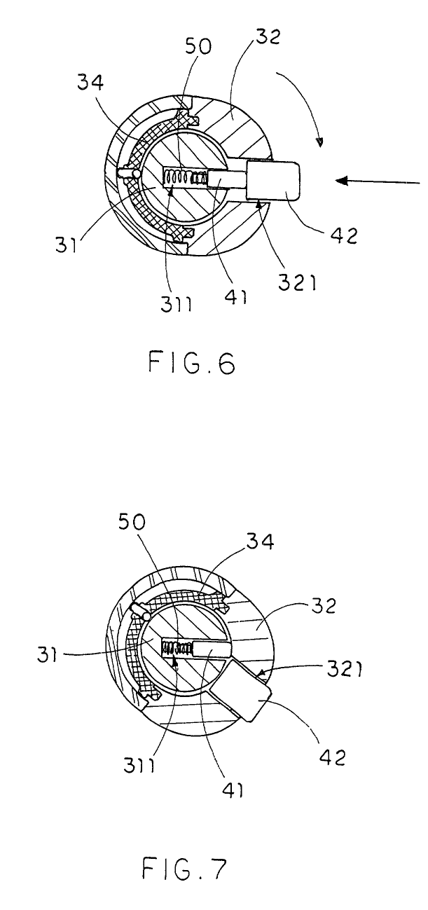

As shown in FIGS. 6 and 7, the pusher cavity 311 has a predetermined depth that the locking latch 41 is pushed inward enough to move away from the blocking wall 322 of the turning handle 32.

The resilient unit 50, according to the preferable embodiment of the present invention, comprises at least a compression spring which is disposed in the pusher cavity 311 and is provided between a bottom surface of the pusher cavity 311 and the locking latch 41. The resilient unit 50 has two ends biasing against the locking latch 41 and the bottom surface of the pusher cavity 311. Accordingly, the resilient unit 50 will normally urge and retain the locking latch 41 in an outer position that the outer end of the locking latch 41 is extended to the blocking wall 322 of the turning handle 32 to block up the turning handle 32 from being rotated with respect to the pivot arms 121, SO as to lock up the foldable stroller from being folded up.

The finger trigger 42 is slidably mounted on the turning handle 32 through the guiding slot 321 and arranged to move the locking latch 41 inward into the pusher cavity 311 until the outer end of the locking latch 41 is moved away from the blocking wall 322 of the turning handle 32. For enhancing the operability of one-hand operational control device 2, the finger trigger 42 has a W-shape to form a W-shaped gripping surface 421 for the user's fingers fittedly gripping thereon.

In order to unlock the one-hand operational control device 2, the user must intentionally grip on the finger trigger 42 by his or her fingers and apply an inward force F1 on the finger trigger 42 in order to inwardly move the locking latch 42 until the outer end of the locking latch 42 is moved away from the blocking wall 322 of the turning handle 32. At this unlocked position, a forward rotational force F2 can be applied on the turning handle 32 to rotate forward, so as to drive the first engaging members 21 to disengage with the second members 22 respectively. Therefore, the user can pivotally push the handle frame 12 towards to supporting frame 11 to fold up the foldable stroller 1. Due to the mechanism of the human body, the user can easily grip on the finger trigger 42 to press it inward, rotate the turn switch 30 to unlock the foldable stroller 1, and push the handle frame 12 to fold up the foldable stroller 1 in a single continuous motion.

While releasing the forward rotational force F2, the auto-returning element 24 will rebound to its original form which rotatably pushes the turning handle 32 rearwardly to the original position. Furthermore, the compressed resilient unit 50 will then rebound outwardly and force the locking latch 41 to extend to the blocking wall 322 of the turning handle 32, so as to remain the locking latch 41 at its original lock-up position.

What is claimed is:

1. A foldable stroller, comprising:
a foldable supporting frame;
a handle frame comprising two pivot arms extending downwardly;
a pair of folding joints for pivotally connecting two lower ends of said pivot arms to two sides of said supporting frame respectively;
an engagement unit comprising a pair of first engaging members provided at two lower ends of said pivot arms of said handle frame respectively and a pair of second engaging members provided at said two folding joints and securely engaged with said two first engaging members respectively, so as to lock up said handle frame with said supporting frame; and
an one-hand operational control device, comprising:
a turn switch, which is arranged to drive said first engaging members to disengage with said second engaging members respectively, comprising a central shaft which has a pusher cavity being firmly and coaxially mounted between two upper ends of said pivot arms and a turning handle which has a guiding slot being rotatably and coaxially mounted on said central shaft and arranged to drive said first engaging members to disengage with said second engaging members respectively, wherein said turning handle further comprises a blocking wall inwardly extended towards said pusher cavity;
a locking unit comprising a locking latch disposed in said pusher cavity of said turn switch in a slidably movable manner and a finger trigger extended from said locking latch to outside through said guiding slot, wherein said locking latch is arranged to be driven by said finger trigger to move from a normally locking position to an locked position; and
a resilient unit, which is disposed in said pusher cavity for applying an urging pressure against said locking latch so as to normally retain said locking latch at said locking position, wherein at said locking position, a locking portion of said locking latch is extended outwardly for blocking up said turn switch from being rotated by said blocking wall so as to lock up said foldable stroller from being folded up, and that at said unlocked position, said locking portion of said locking latch is moved away from said blocking wall of said turn switch so as to release said blocking up of said turn switch with respect to said pivot arms, therefore said turn switch is capable of being rotated to disengage said first engaging members with said second engaging members respectively.

2. A foldable stroller, as recited in claim 1, wherein said locking latch is slidably fitted in said pusher cavity in a perpendicularly movable manner with respect to said central shaft, wherein said resilient unit is provided between a bottom surface of said pusher cavity and said locking latch for urging and retaining said locking latch in an outer position that an outer end of said locking latch is extended to said blocking wall of said turning handle so as to block up said turning handle from being rotated with respect to said pivot arms, wherein said finger trigger is arranged to move said locking latch inward into said pusher cavity until said outer end of said locking latch is moved away from said blocking wall of said turning handle.

3. A foldable stroller, as recited in claim 1, wherein said engagement unit further comprises a pair of elongated elements each having an affixing end firmly connected to said central shaft of said turn switch and a control end firmly connected to said respective first engaging member in such a manner that when said turning handle is rotated forward with respect to said pivot arms, said first engaging members are disengaged with said second engaging members via said elongated elements respectively.

4. A foldable stroller, as recited in claim 2, wherein said engagement unit further comprises a pair of elongated elements each having an affixing end firmly connected to said central shaft of said turn switch and a control end firmly connected to said respective first engaging member in such a manner that when said turning handle is rotated forward with respect to said pivot arms, said first engaging members are disengaged with said second engaging members via said elongated elements respectively.

5. A foldable stroller, as recited in claim 1, wherein said supporting frame comprises a front frame, a back frame pivotally connected to said front frame and a seat handle frame is pivotally moved forward, said back frame is arranged to pivotally fold towards to said front frame so as to fold up said foldable stroller.

6. A foldable stroller, as recited in claim 2, wherein said supporting frame comprises a front frame, a back frame pivotally connected to said front frame and a seat frame pivotally supported by said front and back frames in such a manner that when said handle frame is pivotally moved forward, said back frame is arranged to pivotally fold towards to said front frame so as to fold up said foldable stroller.

7. A foldable stroller, as recited in claim 3, wherein said supporting frame comprises a front frame, a back frame pivotally connected to said front frame and a seat frame pivotally supported by said front and back frames in such a manner that when said handle frame is pivotally moved forward, said back frame is arranged to pivotally fold towards to said front frame so as to fold up said foldable stroller.

8. A foldable stroller, as recited in claim 4, wherein said supporting frame comprises a front frame, a back frame pivotally connected to said front frame and a seat frame pivotally supported by said front and back frames in such a manner that when said handle frame is pivotally moved forward, said back frame is arranged to pivotally fold towards to said front frame so as to fold up said foldable stroller.

9. A foldable stroller, as recited in claim 1, wherein said finger trigger has a W-shape to form a W-shaped gripping surface for the user's fingers fittedly gripping thereon, so as to apply an inward force on said finger trigger.

10. A foldable stroller, as recited in claim 2, wherein said finger trigger has a W-shape to form a W-shaped gripping surface for the user's fingers fittedly gripping thereon, so as to apply an inward force on said finger trigger.

11. A foldable stroller, as recited in claim 3, wherein said finger trigger has a W-shape to form a W-shaped gripping surface for the user's fingers fittedly gripping thereon, so as to apply an inward force on said finger trigger.

12. A foldable stroller, as recited in claim 4, wherein said finger trigger has a W-shape to form a W-shaped gripping surface for the user's fingers fittedly gripping thereon, so as to apply an inward force on said finger trigger.

13. A foldable stroller, as recited in claim 5, wherein said finger trigger has a W-shape to form a W-shaped gripping surface for the user's fingers fittedly gripping thereon, so as to apply an inward force on said finger trigger.

14. A foldable stroller, as recited in claim 6, wherein said finger trigger has a W-shape to form a W-shaped gripping surface for the user's fingers fittedly gripping thereon, so as to apply an inward force on said finger trigger.

15. A foldable stroller, as recited in claim 7, wherein said finger trigger has a W-shape to form a W-shaped gripping surface for the user's fingers fittedly gripping thereon, so as to apply an inward force on said finger trigger.

16. A foldable stroller, as recited in claim 8, wherein said finger trigger has a W-shape to form a W-shaped gripping surface for the user's fingers fittedly gripping thereon, so as to apply an inward force on said finger trigger.

17. A foldable stroller, as recited in claim 4, wherein said turn switch further comprises a driving member firmly connected to said central shaft wherein said driving member has at least a protrusion extended outwardly and engaged with said turning handle so as to ensure said turning handle to drive said central shaft said to rotate.

18. A foldable stroller, as recited in claim 8, wherein said turn switch further comprises a driving member rotatably mounted on said central shaft wherein said driving member has at least a protrusion extended outwardly and engaged with said turning handle so as to ensure said turning handle to rotate with respect to said central shaft.

19. A foldable stroller, as recited in claim 12, wherein said turn switch further comprises a driving member rotatably mounted on said central shaft wherein said driving member has at least a protrusion extended outwardly and engaged with said turning handle so as to ensure said turning handle to rotate with respect to said central shaft.

20. A foldable stroller, as recited in claim 16, wherein said turn switch further comprises a driving member rotatably mounted on said central shaft wherein said driving member has at least a protrusion extended outwardly and engaged with said turning handle so as to ensure said turning handle to rotate with respect to said central shaft.
